(19) United States
(12) Patent Application Publication
(10) Pub. No.: US 2025/0379453 A1
(43) Pub. Date: Dec. 11, 2025

(54) CONTROL CIRCUIT FOR A CONNECTING CABLE AND THE CONNECTING CABLE

(71) Applicants: Yujun Li, Shenzhen (CN); Peiyuan Kang, Shenzhen (CN)

(72) Inventors: Yujun Li, Shenzhen (CN); Peiyuan Kang, Shenzhen (CN)

(21) Appl. No.: 19/229,338

(22) Filed: Jun. 5, 2025

(30) Foreign Application Priority Data
Jun. 6, 2024 (CN) 202421287575.1

(51) Int. Cl. H02J 7/00

(52) U.S. Cl. CPC H02J 7/00045; H02J 7/0036; H02J 7/00712; H02J 2207/30

(57) ABSTRACT

A control circuit for a connecting cable and the connecting cable comprises an input end connected to an adapter or power bank, and an output end connected to a peripheral device; a charging circuit is connected between the input end and the output end; the control circuit further includes a main control circuit and a starting circuit connected to the main control circuit; the main control circuit is electrically connected to the charging circuit; the starting circuit is connected to the output end, and the starting circuit enables the input end to adapt to the protocol of the adapter or power bank, after which the charging circuit provides electrical signals to the output end for charging the peripheral device; by arranging a starting module in the circuit and using the starting module+housing to ensure stable startup of the connecting cable, the startup is more reliable.

### TECHNICAL FIELD

The invention relates to the technical field of control circuits for connecting cables and connecting cables, in particular to a control circuit for a connecting cable and the connecting cable.

### BACKGROUND ART

USB Type-C connectors are widely used in the field of electronic products due to many advantages such as fast transmission speed and stable transmission performance. USB is the abbreviation of Universal Serial Bus. With the rapid development of communication technology, the USB standard has evolved from USB 2.0 to USB 3.1. Common interface types are divided into Type-A, Type-B, and Type-C, which are applied to electronic products such as floppy disk drives, digital cameras, CD/VCD-ROMs, flash drives, tablets, and mobile phones. In particular, the Type-C interface tends to be widely used in electronic products due to its fast transmission speed, small size, and reversible plugging feature. With the continuous increase in the number of iPhone series users, two ends of iPhone charging data cables generally use Type-C (charger end) and Lighting (phone end), resulting in that iPhone charging data cables can only charge unidirectionally and cannot perform bidirectional charging. This brings great limitations in use and fails to provide greater convenience for users. Existing connecting cables suitable for Type-C and Lighting often have their casings treated as suspended structures. Since the casing is connected to the control board through solder joints, long-term plugging and unplugging easily cause the solder joints to loosen, leading to poor contact, invalidation of the starting circuit, and failure of the connecting cable to work normally. At the same time, due to the settings of the electronic components in the connecting cable, it cannot be adapted to adapters or power banks with different power ratings.

Chinese patent publication No. CN216720988U relates to a Lighting-based bidirectional charging device, including a charger with a Lighting charging interface and a Type-C charging interface. The Lighting charging interface is used to connect to a Type-C charging head, and the Type-C charging interface is used to connect to a Type-C charging head. The charger is equipped with a unidirectional charging circuit for connecting the Type-C charging head to the Lighting charging head. The Lighting charging interface of the charger also has a charging control circuit, and inside the charger is provided with a protocol circuit that communicates with the chip of the charging control circuit. When the protocol circuit communicates with the chip of the control circuit, reverse charging is achieved. The invention realizes the bidirectional charging function, that is, it can realize charging from a Type-C charging head to a Lighting charging head and vice versa. Using one charging data cable can serve two types of devices, allowing users to achieve bidirectional charging through the data cable, making the data cable dual-purpose, improving usage efficiency, and increasing convenience. Although this patent provides a bidirectional charging device, the connection of its casing via a pull-down resistor is prone to looseness after long-term plugging and unplugging, resulting in poor contact. Additionally, it cannot adapt to power banks and adapters with different power levels.

### SUMMARY OF THE INVENTION

The technical problem to be solved by the invention is that existing connecting cables suitable for Type-C and Lighting often have their casings treated as suspended structures for startup. Since the casing is connected to the control board via solder joints, frequent plugging and unplugging over time can cause the solder joints to loosen, leading to poor contact, invalidation of the starting circuit, and failure of the connecting cable to work properly. Meanwhile, due to the configuration of electronic components in the connecting cable, it cannot adapt to adapters or power banks with different power ratings. Aiming at the above defects in the prior art, a control circuit for a connecting cable and the connecting cable are provided.

To solve the above technical problem, the technical solution adopted in the invention is as follows:
a control circuit for a connecting cable is constructed, comprising an input end connected to an adapter or power bank, and an output end connected to a peripheral device; a charging circuit is connected between the input end and the output end; the control circuit further includes a main control circuit and a starting circuit connected to the main control circuit; the main control circuit is electrically connected to the charging circuit; the starting circuit is connected to the output end, and the starting circuit enables the input end to adapt to the protocol of the adapter or power bank, after which the charging circuit provides electrical signals to the output end for charging the peripheral device.

Preferably, the starting circuit is electrically connected to the input end and the starting circuit is grounded; when the output end is not connected to a peripheral device, the electrical signal of the adapter is grounded through the starting circuit.

Preferably, the starting circuit is directly connected to the output end, and the electrical signal undergoes protocol adaptation directly through the starting circuit, or is connected to the output end through the main control circuit, with the electrical signal transmitted to the starting circuit through the main control circuit for protocol adaptation.

Preferably, the main control circuit is connected to the output end through the starting circuit.

Preferably, the charging circuit includes a starting module connected to the input end and the output end, and a first protection module connected to the input end; the first protection module is connected to the output end through a power switch module, and the first protection module is connected to the main control circuit; when the starting module detects an electrical signal, the power switch module is turned on to allow the charging circuit to conduct electrical signals.

Preferably, the starting module includes a matching module connected to the input end and a signal switch module connected to the output end; the signal switch module is further connected to a second protection module, which is electrically connected to the matching module; when the signal switch module is turned on to conduct the starting circuit, protocol adaptation is achieved, and the charging circuit can perform charging operations.

Preferably, the second protection module is electrically connected to the main control circuit and connected to the output end through the main control circuit; the second protection module and the matching module are grounded, and the signal switch module is driven to turn on by the main control circuit.

Preferably, the second protection module is connected to the output end through a signal switch driving module; the second protection module and the signal switch driving module are connected to a power storage module, and the power storage module enhances the driving capability of the signal switch module.

Preferably, the signal switch module is connected to an anti-floating module, and the anti-floating module and the power storage module are grounded.

A connecting cable is constructed, comprising the above-described control circuit for a connecting cable; the connecting cable includes a connector L-port serving as an output end, the connector L-port includes a housing and L-shaped ground pads disposed inside the housing; L-shaped ground pads contact the housing to ground the control circuit.

The beneficial effects of the invention are as follows: by arranging a starting module in the circuit and using the starting module+housing to ensure stable startup of the connecting cable, the startup is more reliable. The matching resistor set in the circuit dynamically adjusts the resistance value of the starting circuit, enabling it to adapt to different adapters or power banks and expanding the scope of application. Current limiting circuits are provided in both the charging circuit and the starting circuit to prevent static electricity surge and protect circuit safety. Meanwhile, the anti-floating module avoids signal switch floating, improving safety; the power storage module enhances the driving capability of the signal switch module, making the starting circuit more driven and convenient for charging. Multiple solutions ensure that the starting circuit can be activated to turn on the charging circuit for charging whether the mobile phone has power or not.

### BRIEF DESCRIPTION OF ACCOMPANY DRAWINGS

To more clearly illustrate the technical solutions in the embodiments of the invention or prior art, the invention will be further described below in conjunction with the drawings and embodiments. The drawings described below are only partial embodiments of the invention. For those of ordinary skill in the art, other drawings can be obtained based on these drawings without creative efforts:

FIG. 1 is a structural principle block diagram of a control circuit for a connecting cable according to a first preferred embodiment of the invention;

FIG. 2 is a structural principle block diagram of a charging circuit according to the first preferred embodiment of the invention;

FIG. 3 is a structural principle block diagram of a starting circuit according to the first preferred embodiment of the invention;

FIG. 4 is a specific circuit diagram of the control circuit for the connecting cable according to the first preferred embodiment of the invention;

FIG. 5 is a structural principle block diagram of a control circuit for a connecting cable according to a second preferred embodiment of the invention;

FIG. 6 is a structural principle block diagram of a starting circuit according to the second preferred embodiment of the invention;

FIG. 7 is a specific circuit diagram of the control circuit for the connecting cable according to the second preferred embodiment of the invention;

FIG. 8 is a structural principle block diagram of a control circuit for a connecting cable according to a third preferred embodiment of the invention;

FIG. 9 is a structural principle block diagram of a starting circuit according to the third preferred embodiment of the invention;

FIG. 10 is a specific circuit diagram of the control circuit for the connecting cable according to the third preferred embodiment of the invention;

FIG. 11 is a structural diagram after an L-port of the connector is grounded in the in preferred embodiment of the invention.

### SPECIFIC EMBODIMENT OF THE INVENTION

To make the objectives, technical solutions, and advantages of the embodiments of the invention clearer, the technical solutions in the embodiments of the invention will be clearly and completely described below. Obviously, the described embodiments are partial embodiments of the invention, rather than all embodiments. Based on the embodiments of the invention, all other embodiments obtained by those of ordinary skill in the art without creative efforts fall within the protection scope of the invention.

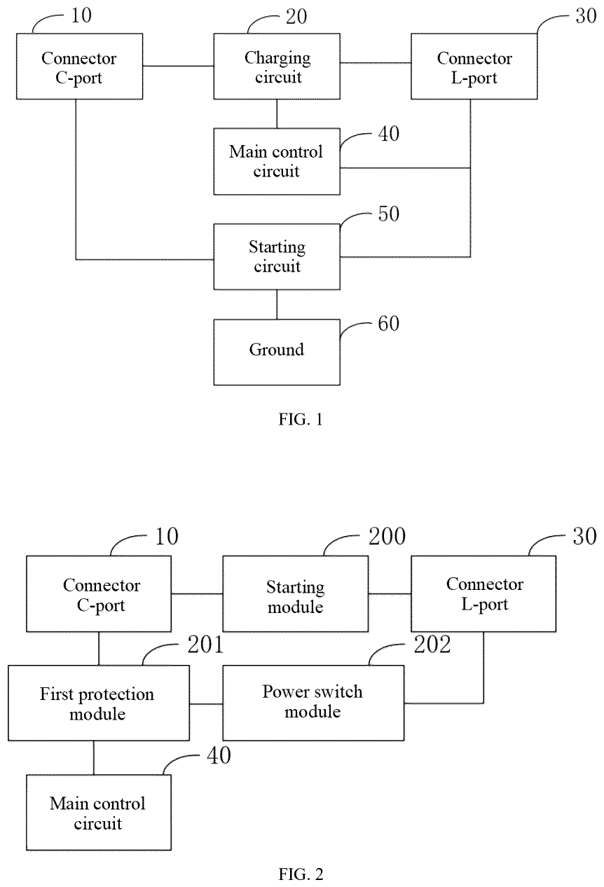

A control circuit for a connecting cable according to a first preferred embodiment of the invention; as shown in FIG. 1, it includes a connector C-port 10 connected to an input end and a connector L-port 30 connected to an output end; a charging circuit 20 is connected between the connector C-port 10 and the connector L-port, as well as a main control circuit 40 connected to the connector L-port; the main control circuit is connected to the charging circuit. The control circuit further includes a starting circuit 50 connecting the connector C-port and the connector L-port, and the starting circuit is connected to a ground 60. When the connector L-port is connected to a device for output, the device's power activates the starting circuit 50 and transmits an electrical signal to the main control circuit, after which the connector C-port charges the device through the charging circuit. The connector C-port is a TYPE-C interface or similar, connected to a power adapter or connecting cable as an electrical signal input; the connector L-port is an Apple Lightning interface, connected to a mobile phone or other devices for charging such devices.

Specifically, as shown in FIG. 2, the charging circuit 20 includes a starting module connected to the connector L-port 30, with an other end of the starting module connected to the connector C-port. Meanwhile, the connector L-port is connected to a power switch module 202, and the power switch module 202 is connected to the connector C-port after connecting with a first protection module 201, and is also connected to the main control circuit 40.

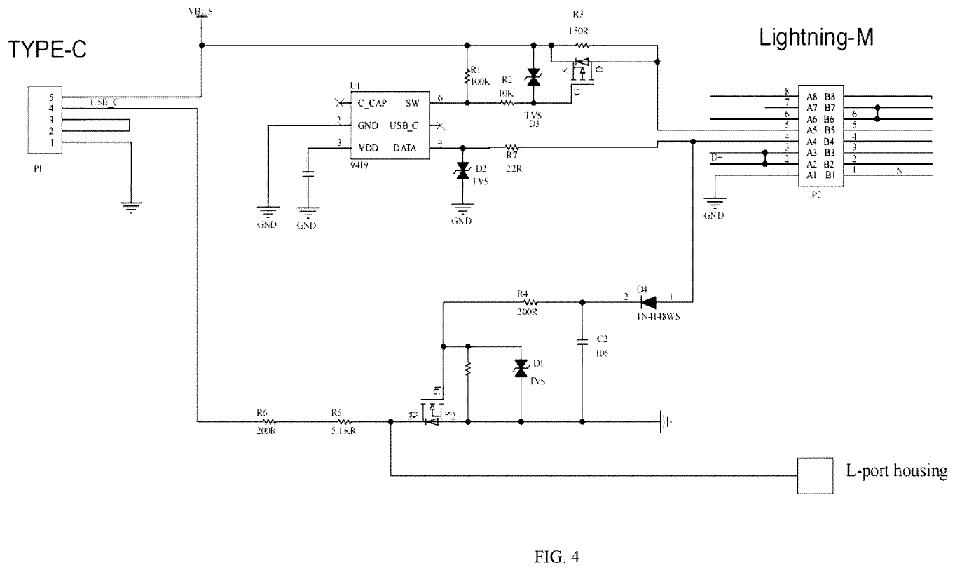

Further, as shown in FIG. 4, the first protection module 201 includes a first resistor R1 and a second resistor R2 connected to the main control circuit; the first resistor and the second resistor are connected in parallel, and an other end of the second resistor is connected to a third bidirectional voltage regulator diode D3, with an other end of the third bidirectional voltage regulator diode connected to an other end of the first resistor. The first protection module composed of the first resistor R1, the second resistor R2, and the third bidirectional voltage regulator diode D3 limits current to enhance driving capability during charging and prevent static electricity surge. The power switch module 202 is a first MOS transistor Q1, the first MOS transistor adopts a PMOS transistor, with its source S connected to the connector C-port, drain D connected to the connector L-port, and gate G connected to the first protection module; the starting module 200 is a third detection resistor R3, with one end connected to the connector C-port and the source S, and an other end connected to the connector L-port and the drain D. When a mobile phone or charging device has no power, the third resistor detects current and acts as a starting resistor to activate the protocol, turning on the first MOS transistor for charging.

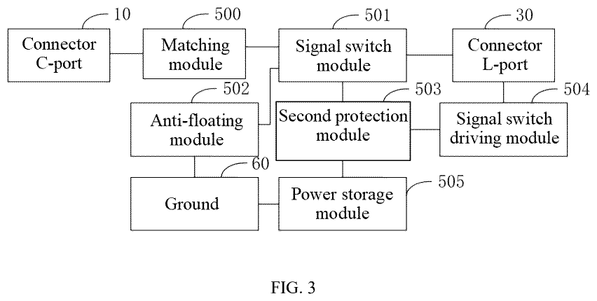

Further, as shown in FIG. 3, the starting circuit 50 includes a matching module 500 connected to the connector C-port 10 and a signal switch module 501 connected to the matching module, with the signal switch module connected to the connector L-port 30. The signal switch module 501 is further connected to a second protection module 503 and an anti-floating module 502. The second protection module is connected to the connector L-port through a signal switch driving module 504. The anti-floating module 502 is connected to ground 60, and the second protection module 503 is connected to a power storage module 505 before grounding.

Further, as shown in FIG. 4, the matching module 500 includes a fifth resistor R5 and a sixth resistor R6 connected in series; the fifth resistor may have a fixed resistance value, while the sixth resistor has a variable resistance value, allowing the matching module to adapt to voltage and current, and match CC voltage of different protocol main controllers to accommodate different connecting cables or adapters. The signal switch module 501 uses a second MOS transistor, which adopts an NMOS transistor, with its drain D connected to the matching module, source S grounded, and gate G connected to the second protection module 503 and the anti-floating module 502. The anti-floating module 502 uses an eighth resistor R8 connected in parallel across the source S and gate G, with a first bidirectional voltage regulator diode D1 also connected in parallel across both ends. The gate G is connected to a fourth resistor R4, and the second protection module composed of the fourth resistor and the first bidirectional voltage regulator diode limits current and prevents static electricity surge. The fourth resistor R4 is connected to the connector L-port through a fourth diode D4, with the fourth resistor connected to an cathode of the fourth diode and also grounded through a second capacitor C2. When the connector L-port is inserted into a mobile phone with remaining power, the fourth diode turns on, allowing the main control circuit to detect the remaining power, after which the connector C-port charges the mobile phone through the charging circuit. The eighth resistor prevents floating by grounding the second MOS transistor through the eighth resistor when the mobile phone has no power and the connector C-port is connected to an adapter. The second capacitor C2 stores power to enhance the driving capability of the second MOS transistor.

During use, when the connector L-port is not inserted into a mobile phone, the starting circuit is disconnected and inactive, with the CC signal turned off, and the adapter or connecting cable does not output voltage or current. When the connector L-port is inserted into a mobile phone, the fourth diode turns on and activates the second MOS transistor, turning on the CC signal, allowing the adapter to output voltage. After the connector L-port is connected to the mobile phone, the mobile phone's electrical signal is conducted through the signal switch driving module, then limited by the second protection module, transmitted to the signal switch module, and activates the signal switch module. The matching module adjusts the voltage and resistance to activate the CC signal, after which the charging module charges the mobile phone. Due to the anti-floating module, when the connector L-port is not connected to a device, the eighth resistor grounds the electrical signal to a low-level state.

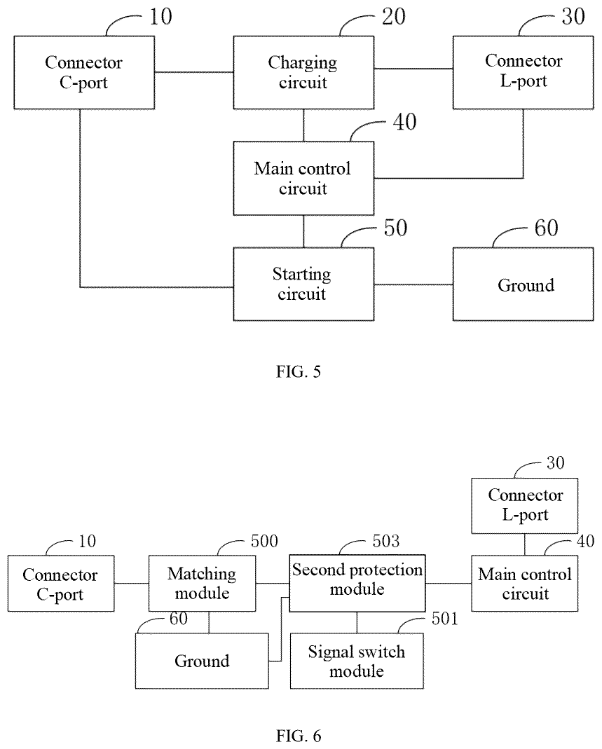

A control circuit for a connecting cable according to a second preferred embodiment of the invention; as shown in FIG. 5, the difference from the first embodiment is that the starting module 200 is connected to the connector L-port 30 through the main control circuit 40. As shown in FIG. 6, since the charging module is directly connected to the main control circuit, driving the signal switch module 501 is directly provided by the main control circuit 40, eliminating the need for a signal switch driving module 504, power storage module 505, and anti-floating module 502.

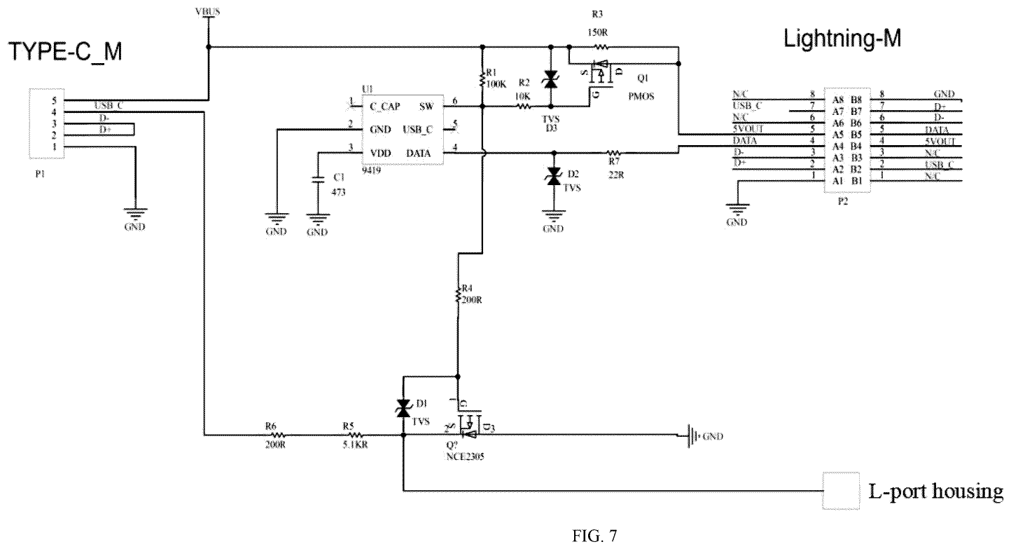

Further, as shown in FIG. 7, the fifth resistor R5 is connected in series with a first voltage regulator diode D1 and a fourth resistor R4, with an other end of the fourth resistor connected to the main control circuit; the fifth resistor is also connected to a second MOS transistor. In the second embodiment, the MOS transistor is a PMOS transistor, with its source S connected to the fifth resistor and one end of the first voltage regulator diode, gate G connected to an other end of the first voltage regulator diode and the fourth resistor, drain D grounded, and the source S connected to the housing of the connector L-port. When the mobile phone has no power, the CC signal cannot activate the adapter, the charging circuit cannot operate, and the connector L-port is forcibly grounded. It should be noted that the forced grounding scheme for the connector L-port can also be applied to the first embodiment, although this connection is not shown in the first embodiment.

During use, after the connector L-port is connected to the mobile phone, the electrical signal is transmitted to the main control chip, which simultaneously turns on the second MOS transistor and the first MOS transistor. Turning on the second MOS transistor activates the CC signal, while turning on the first MOS transistor activates the charging circuit to charge the mobile phone.

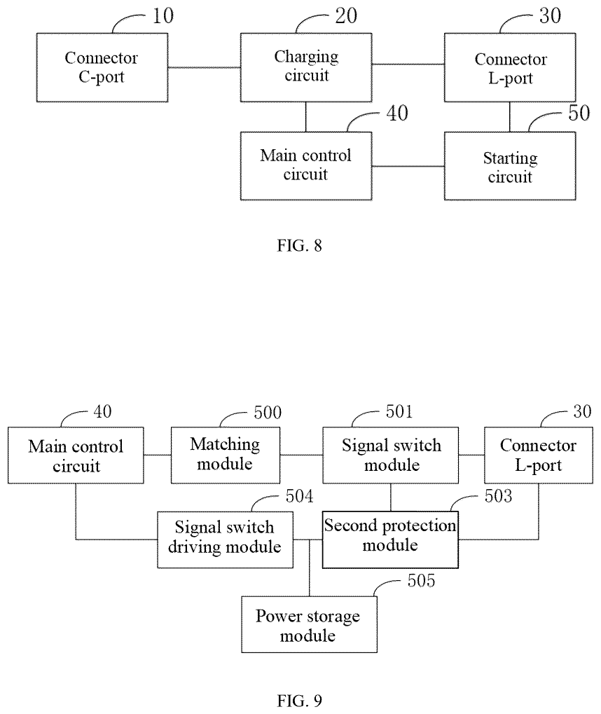

A control circuit for a connecting cable according to a third preferred embodiment of the invention; as shown in FIG. 8, the difference from the first embodiment is that the connector C-port 10 is only connected to the charging circuit 20 and not to the starting circuit 50, with the main control circuit 40 connected to the connector L-port 30 through the starting circuit 50.

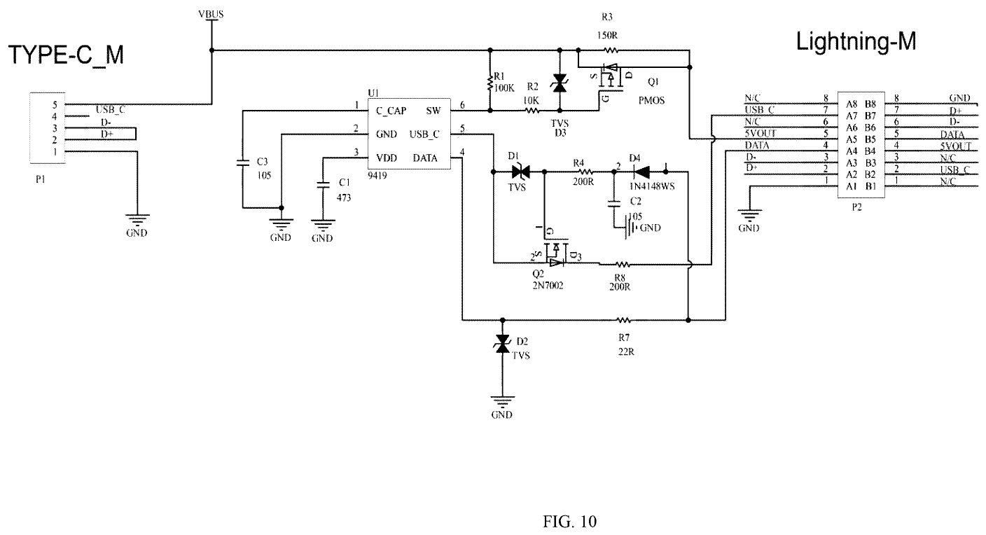

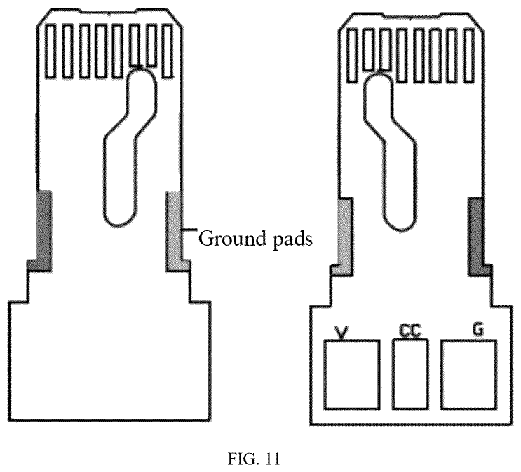

Further, as shown in FIG. 9, the main control circuit 40 is connected to the matching module 500 and the signal switch driving module 504, with the signal switch driving module connected to the power storage module. Other connections are the same as in the first embodiment and will not be repeated here. As shown in FIG. 10, the source S of the second MOS transistor is connected to the main control circuit, the gate G is connected to the second protection module, and the drain D is connected to the eighth resistor R8 and then to the connector L-port.

During use, when the connector L-port is connected to the mobile phone, the fourth diode D4 turns on, driving the second MOS transistor to activate the CC protocol of the main control circuit, allowing the adapter to transmit electrical signals and charge through the charging circuit. It should be noted that the third embodiment is only applicable when the mobile phone still has power to activate the CC protocol for charging, while the first and second embodiments can activate the CC protocol for charging whether the mobile phone has power or not.

A connecting cable according to a preferred embodiment of the invention; the connecting cable includes a control circuit for a connecting cable as described above, with the specific control circuit being the same as above and not repeated here. As shown in FIG. 11, the connector L-port is provided with L-shaped ground pads that contact a housing of the connector L-port for grounding. Two sets of L-shaped ground pads are provided, respectively arranged on the left and right sides.

It should be understood that the invention is described through some embodiments, and those skilled in the art will appreciate that various changes or equivalent substitutions can be made to these features and embodiments without departing from the spirit and scope of the invention. Additionally, under the guidance of the invention, these features and embodiments can be modified to adapt to specific situations and materials without departing from the spirit and scope of the invention. Therefore, the invention is not limited by the specific embodiments disclosed herein, and all embodiments falling within the scope of the claims of the invention are within the protection scope of the invention.

1. A control circuit for a connecting cable, comprising an input end connected to an adapter or power bank, and an output end connected to a peripheral device; a charging circuit is connected between the input end and the output end; the control circuit further includes a main control circuit and a starting circuit connected to the main control circuit; the main control circuit is electrically connected to the charging circuit; the starting circuit is connected to the output end, and the starting circuit enables the input end to adapt to the protocol of the adapter or power bank, after which the charging circuit provides electrical signals to the output end for charging the peripheral device.

2. The control circuit according to claim 1, wherein the starting circuit is electrically connected to the input end and the starting circuit is grounded; when the output end is not connected to a peripheral device, the electrical signal of the adapter is grounded through the starting circuit.

3. The control circuit according to claim 2, wherein the starting circuit is directly connected to the output end, and the electrical signal undergoes protocol adaptation directly through the starting circuit, or is connected to the output end through the main control circuit, with the electrical signal transmitted to the starting circuit through the main control circuit for protocol adaptation.

4. The control circuit according to claim 1, wherein the main control circuit is connected to the output end through the starting circuit.

5. The control circuit according to claim 1, wherein the charging circuit includes a starting module connected to the input end and the output end, and a first protection module connected to the input end; the first protection module is connected to the output end through a power switch module, and the first protection module is connected to the main control circuit; when the starting module detects an electrical signal, the power switch module is turned on to allow the charging circuit to conduct electrical signals.

6. The control circuit according to claim 5, wherein the starting module includes a matching module connected to the input end and a signal switch module connected to the output end; the signal switch module is further connected to a second protection module, which is electrically connected to the matching module; when the signal switch module is turned on to conduct the starting circuit, protocol adaptation is achieved, and the charging circuit can perform charging operations.

7. The control circuit according to claim 6, wherein the second protection module is electrically connected to the main control circuit and connected to the output end through the main control circuit; the second protection module and the matching module are grounded, and the signal switch module is driven to turn on by the main control circuit.

8. The control circuit according to claim 6, wherein the second protection module is connected to the output end through a signal switch driving module; the second protection module and the signal switch driving module are connected to a power storage module, and the power storage module enhances the driving capability of the signal switch module.

9. The control circuit according to claim 8, wherein the signal switch module is connected to an anti-floating module, and the anti-floating module and the power storage module are grounded.

10. A connecting cable, comprising a control circuit for a connecting cable of claim 1; the connecting cable includes a connector L-port serving as an output end, the connector L-port includes a housing and L-shaped ground pads disposed inside the housing; L-shaped ground pads contact the housing to ground the control circuit.
